(19) United States
(12) Patent Application Publication
(10) Pub. No.: US 2020/0086520 A1
(43) Pub. Date: Mar. 19, 2020

(54) ATTACHING SYSTEM

(71) Applicant: GRASSELLI S.P.A., ALBINEA (RE) (IT)

(72) Inventor: GIORGIO GRASSELLI, ALBINEA (IT)

(21) Appl. No.: 16/566,315

(22) Filed: Sep. 10, 2019

(30) Foreign Application Priority Data
Sep. 14, 2018 (IT) 102018000008606

(51) Int. Cl. B26D 7/26; B26D 1/11

(52) U.S. Cl. CPC B26D 7/2614; B26D 2210/02; B26D 1/11

(57) ABSTRACT

Described is system (2) for fastening blades for cutting food products, designed for use in a slicing machine, comprising a support frame (10, 11) which includes a crosspiece (10, 11) provided with a plurality of gripping elements (12), each designed to receive a respective fastening member (21, 22) provided on one of said blades (2), characterised in that: the elements (12) include two rectilinear contact surfaces (120, 121) set at an angle to each other; and that the blades (2) are equipped with polygonal members (21, 22), having two sides designed to make contact at the same time with the two contact surfaces (120, 121).

This invention relates to an improved fastening system for the blades of an industrial slicing machine.

More specifically, the industrial slicing machine advantageously applied according to the invention is used in the food industry for cutting products such as meat, poultry, fish, vegetables preferably cooked or cooked and without bones or cartilage.

More in detail, the industrial slicing machine is used to turn the food product into slices, strips or cubes of various sizes on the basis of the final use.

By way of example, the industrial slicing machine is used in the processing of frozen or pre-cooked products for large-scale organised distribution or fresh or pre-cooked products for school or company canteens, etc.

There are prior art slicing machines in the name of the Applicant which comprise a cutting station equipped with a plurality of cutting blades mounted parallel and joined at opposite ends by respective crosspieces.

Each crosspiece comprises a multiplicity of curved prongs, divided into pairs in which a blade is inserted equipped with a circular rivet fixed to the blade close to its end, the rivet receiving a loop or cradle defined by the curvature of the pair of prongs.

The two crosspieces are kept at a predetermined distance which, in combination with the elasticity of the pairs of gripping prongs, allows the blades to be suitably tensioned, for the purpose of optimum cutting of the product. In use, thanks to prior art kinematic mechanisms, the crosspieces and the relative blades are moved as one with oscillating motion to allow the product to be cut which passes through the cutting station and are cut into slices.

Although this system has operated adequately for the correct cutting of the product, it is not, however, completely free from drawbacks.

In fact, it has been noted that, sometimes, on the surface of some slices of meat cut with this system there are slight irregularities, which adopt wave-like shapes which, although not adversely affecting the quality of the product, have an unattractive appearance which can bother the final customer.

The cause of these irregularities lies in the fact that, during the cutting of the product, that is to say, when the blades come into contact with the meat to be sliced, the above-mentioned rivet undergoes small rotational deviations in the respective “cradle” defined by the above-mentioned gripping prongs, with the consequence that the edge of the blade is inclined slightly, producing the wave patterns on the surface of the slices.

The technical purpose which forms the basis of the invention is to propose a system for fastening blades for industrial slicing machines which is able to overcome the above-mentioned drawbacks of the prior art.

The technical purpose is achieved by the fastening system made according to claim 1.

Further features and advantages of the invention are more apparent in the detailed below, with reference to a preferred, non-limiting, embodiment of the fastening system according to the invention as illustrated in the accompanying drawings, in which:

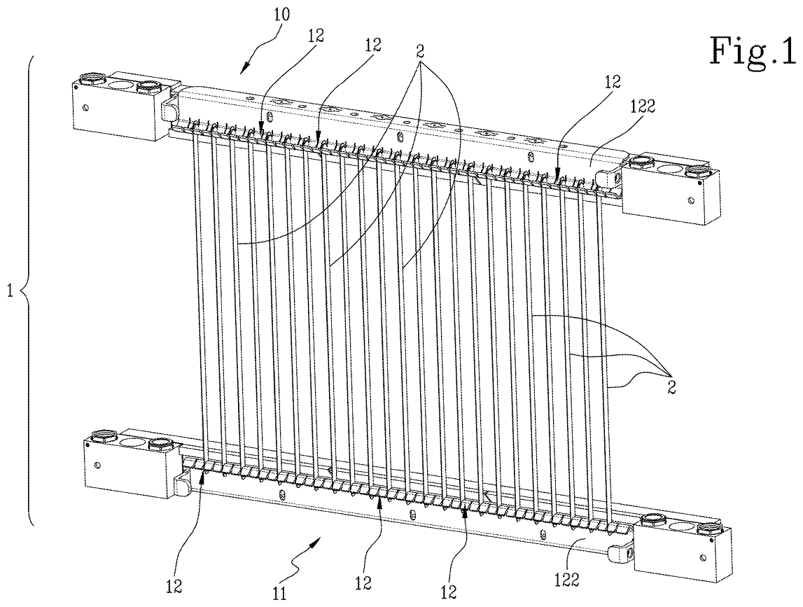

FIG. 1 is an axonometric view of a group of blades connected to a respective frame using the system according to the invention;

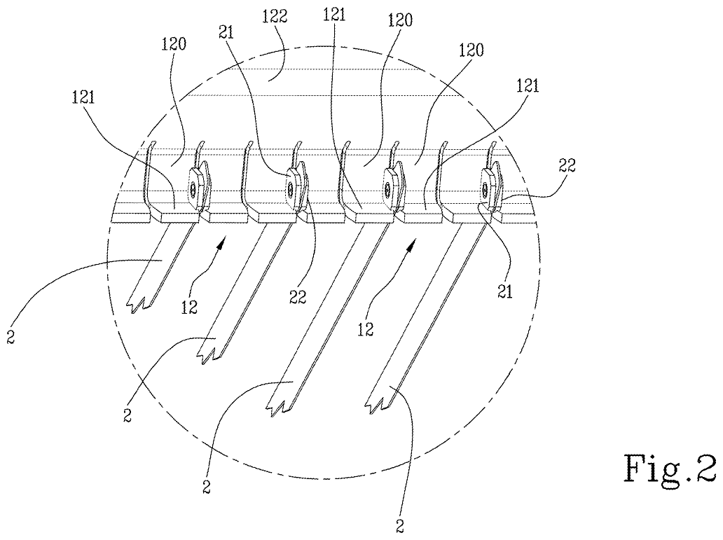

FIG. 2 is an enlarged detail of the previous drawing; and

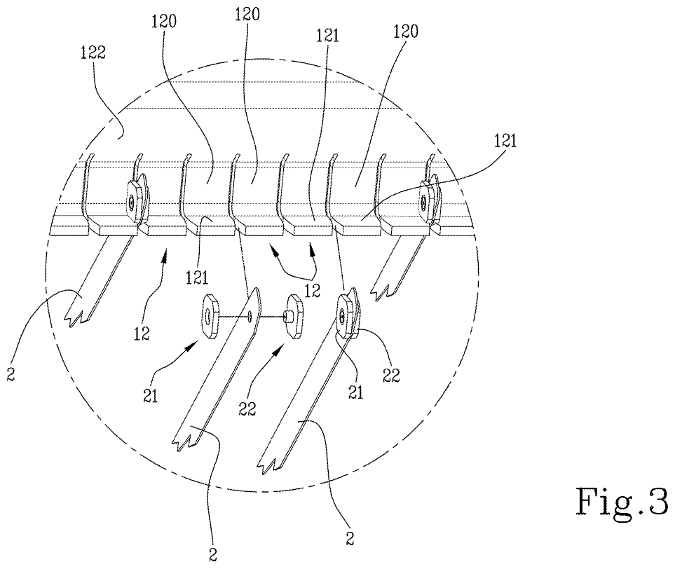

FIG. 3 is an exploded view of the previous drawing.

With reference to the above-mentioned drawings, the numeral 1 denotes a frame 10, 11 and blades 2 to be used in the cutting station of a slicing machine designed for the uses which have already been mentioned in the discussions regarding the prior art.

This type of machine comprises conveyors for carrying products, such as, for example, chicken breasts, to a cutting station where they are cut into slices, strips or even “cubes”, then carried downstream by other conveyors for the purposes of packaging or delivering to other machines of the production line.

More specifically, the blades 2 are mounted parallel to each other, for example vertically, in such a way as to form together a cutting plane transversal to the direction of transport of the products, which is horizontal; the solution described in this application can also operate with the blades 2 positioned horizontally.

The frame 10, 11 which mounts the blades 2 is movable with oscillating and periodic motion along the direction of extension of the blades 2, by means of a kinematic mechanism which can be that illustrated in patent EP2777897 in the name of the same Applicant as this invention, which, with regard to this kinematic mechanism, is considered incorporated herein by reference.

More specifically, each frame 10, 11 present in the cutting station includes two parallel crosspieces 10, 11, preferably made of steel and positioned, for example, horizontally, which join a plurality of blades 2, which are also parallel to each other and preferably made of steel, fastening them at the opposite ends, or close to them.

The crosspieces 10, 11 are kept at a mutual distance such as to develop on the blades 2 the tension which makes it possible to obtain an optimum cut of the food product.

Still more in detail, the cutting station can include two frames, each mounting respective blades 2, the two frames being positioned in such a way that a crosspiece of one is interposed with those of the other, in such a way that the respective blades 2 are alternated; in this case, the movements of the two frames are made in the same ideal plane but offset in such a way that, in use, adjacent blades 2, connected to different frames, move in opposite directions, to favour the slicing of the product.

Each crosspiece 10, 11 is equipped with a plurality of elastic gripping elements 12, which are designed to receive fastening members 21, 22 provided on the blades 2.

According to an important aspect of the invention, the gripping elements 12 each include two rectilinear contact surfaces 120, 121 set at an angle to each other.

More in detail, each gripping element can be a prong 12, or in any case be elongate and protruding from the frame 10, 11, and be bent in such a way as to define its two contact surfaces 120, 121, which are oblique or transversal to each other.

Moreover, as may be seen in FIGS. 2 and 3, the blades 2 are equipped with polygonal members 21, 22, each having two sides designed to simultaneously make contact with two respective contact surfaces 120, 121 of gripping elements 12, to define a constraint between blade and frame 10, 11 which prevents unwanted inclination of the first relative to the second.

In practice, also from this brief description of the invention it may be understood how the anti-rotational block created between the gripping seats of the frames 10, 11, which are each equipped with two angled contact surfaces 120, 121, and the sides with the same angle of the perimeter surface of the members 21, 22 received in the seats, allows the proposed fastening system to completely overcome the limits of the prior art.

In fact, in this way, the blades 2 will no longer undergo a random inclination during the contact with the product, thereby preventing the formation of wave patterns on the surface of the slices.

Preferably, as shown in the accompanying drawings, the above-mentioned fastening elements consist of prongs 12 shaped by a shared bar 122 of the respective crosspiece.

The prongs 12, which preferably are all equal to each other and can be flat as shown in the drawings, receive in pairs a respective blade 2, inserted between them and bent in such a way as to form the gripping seat of the fastening members 21, 22, which is delimited internally by the above-mentioned contact surfaces 120, 121, facing each other.

For example, the prongs 12 may be bent in the form of an elbow, that is to say, like an L or V.

The fastening members 21, 22 of the opposite ends of a given blade 2 are received in the respective seats when the blade 2 is inserted between the respective prongs 12 and are blocked, once the opposite crosspieces 10, 11 have been sufficiently spaced to tension the blade 2.

The fastening members can have a quadrangular perimeter, for example square and are preferably shaped by respective rivets 21, 22 fixed to the blade 2.

More specifically, the rivets form polygonal fastening members 21, 22 which protrude by a predetermined thickness from both sides of the blade 2 so as to each come into contact with the inner surface of a different prong 12 located alongside the blade 2, following assembly (FIGS. 2 and 3).

The two crosspieces 10, 11 can be perfectly symmetrical with respect to a mid-plane and the blades 2 with the respective fastening members 21, 22 are preferably all the same.

1. A cutting station of a slicing machine comprising a plurality of blades (2) for cutting food products and a system for attaching said blades (2) for cutting food products, the system comprising a support frame (10, 11) which includes at least one crosspiece (10, 11) provided with a plurality of gripping elements (12), each designed to receive at least one respective attachment member (21, 22) provided on one of said blades (2), characterised in that:
the elements (12) include at least two rectilinear contact surfaces (120, 121) set at an angle to each other; and that the blades (2) are equipped with polygonal members (21, 22), having two sides designed to make contact at the same time with said two contact surfaces (120, 121).

2. The station according to claim 1, wherein the attachment members (21, 22) are rivets which protrude from both sides of the relative blade (2).

3. The station according to claim 1, wherein the attachment members (12) are prongs which, in pairs, receive a blade (2) inserted between them and are folded in such a way as to define a seat delimited internally by the above-mentioned contact surfaces (10, 121).

4. The station according to claim 3, wherein the prongs (12) are folded in the form of an elbow.

5. The station according to claim 1, wherein the attachment members (21, 22) have a quadrangular perimeter.

6. The station according to claim 1, wherein the frame (10, 11) includes at least two crosspieces (10, 11) the gripping elements (12) of which engage attachment members (21, 22) located at or in the proximity of opposite ends of the cutting blades (2).

7. A slicing machine which includes a cutting station according to claim 1 and movement means for actuating said frame (10, 11) in an alternating motion.
